(19) United States
(12) Patent Application Publication
(10) Pub. No.: US 2016/0285265 A1
(43) Pub. Date: Sep. 29, 2016

(54) METHODS AND SYSTEMS FOR POWER RESTORATION PLANNING EMPLOYING SIMULATION AND A FREQUENCY ANALYSIS TEST

(71) Applicant: ELEON ENERGY, INC., Austin, TX (US)

(72) Inventors: Chenxi Lin, Norman, OK (US); Xiaosong Yang, Austin, TX (US)

(73) Assignee: ELEON ENERGY, INC., Austin, TX (US)

(21) Appl. No.: 14/668,739

(22) Filed: Mar. 25, 2015

(51) Int. Cl. H02J 3/00

(52) U.S. Cl. CPC H02J 3/00; H02J 2003/001; H02J 2003/007

(57) ABSTRACT

A computer system includes at least one processor, and a storage device coupled to at least one processor. The storage devices stores instructions that, when executed, causes the at least one processor to simulate restoration of a power grid system, to perform a frequency analysis test for the simulated restoration, and to generate a restoration plan for the power grid system based on the simulation and frequency analysis test results.

### BACKGROUND

Power system restoration planning tools become more important daily due to the significant amount of uncertainties and risks from integrated variable renewable energy resources, market activities and stressed power system facilities. Typically, restoration planning is an off-line process ensuring an effective coordinated restoration following a wide-area blackout. Due to the size and complexity of the problem, conventional planning tools rely on a number of manual studies based on certain selected load scenarios, size-reduced network models and fixed generation profiles. Conventional planning tools may not be adequate for the future smart-grid with frequent system reconfigurations, variable energy resources and responsive loads.

For example, transmission systems with a large concentration of lighting, motors, and thermostatically controlled loads (e.g., air conditioners, refrigerators, freezers, furnaces, and electric hot water heaters) may produce high inrush currents in the system after prolonged outage times due to cold load pick up phenomenon. This kind of dynamic load behavior is significant during power system restoration as small isolated systems can produce large frequency changes that can activate under frequency load shedding (UFLS) relays, trip online generators, and/or otherwise negatively affect power system restoration. Accounting for cold load pick up issues is not a trivial task as the impact of in-rush current related to cold load pick up differs from traditional frequency related issues where the change of load is not dramatic.

### BRIEF DESCRIPTION OF THE DRAWINGS

Accordingly, there are disclosed herein methods and systems for power restoration planning employing simulation and frequency analysis test. In the drawings:

FIG. 1 is a block diagram showing an overview of an illustrative power restoration planning environment;

FIG. 2 is a block diagram showing an illustrative computer system with a power restoration simulation application;

FIG. 3 is a graph showing a frequency response after a load pick up;

FIG. 4A is a block diagram showing a generator model;

FIG. 4B is a block diagram showing an aggregate generator system model;

FIG. 4C is a block diagram showing a generator model with a first-order governor model;

FIG. 5A is a graph showing load variation following cold load pick up;

FIG. 5B is a graph showing cold load characteristics during system restoration;

FIGS. 6A and 6B are block diagrams and graphs showing a parameter estimation process;

FIGS. 7A and 7B are block diagrams showing a system model for fast frequency calculation;

FIG. 8A is a schematic diagram showing a simulated power system with 39 buses;

FIG. 8B is a schematic diagram representing a first stage of power restoration for the simulated power system of FIG. 8A;

FIG. 8C is a graph representing a frequency response for the first stage of power restoration;

FIG. 8D is a schematic diagram representing a second stage of power restoration for the simulated power system of FIG. 8A;

FIG. 8E is a graph representing a frequency response for the second stage of power restoration;

FIG. 8F is a schematic diagram representing a third stage of power restoration for the simulated power system of FIG. 8A;

FIG. 8G is a graph representing a frequency response for the third stage of power restoration;

FIG. 8H is a schematic diagram representing a fourth stage of power restoration for the simulated power system of FIG. 8A;

FIG. 8I is a graph representing a frequency response for the fourth stage of power restoration;

FIG. 8J is a schematic diagram representing a fifth stage of power restoration for the simulated power system of FIG. 8A;

FIG. 8K is a graph representing a frequency response for the fifth stage of power restoration;

FIGS. 9A-9I are illustrative screenshots corresponding to power restoration simulation software with a frequency analysis test function;

FIG. 10 is a flowchart showing an illustrative power restoration planning method; and

FIG. 11 is a block diagram showing illustrative computer system components.

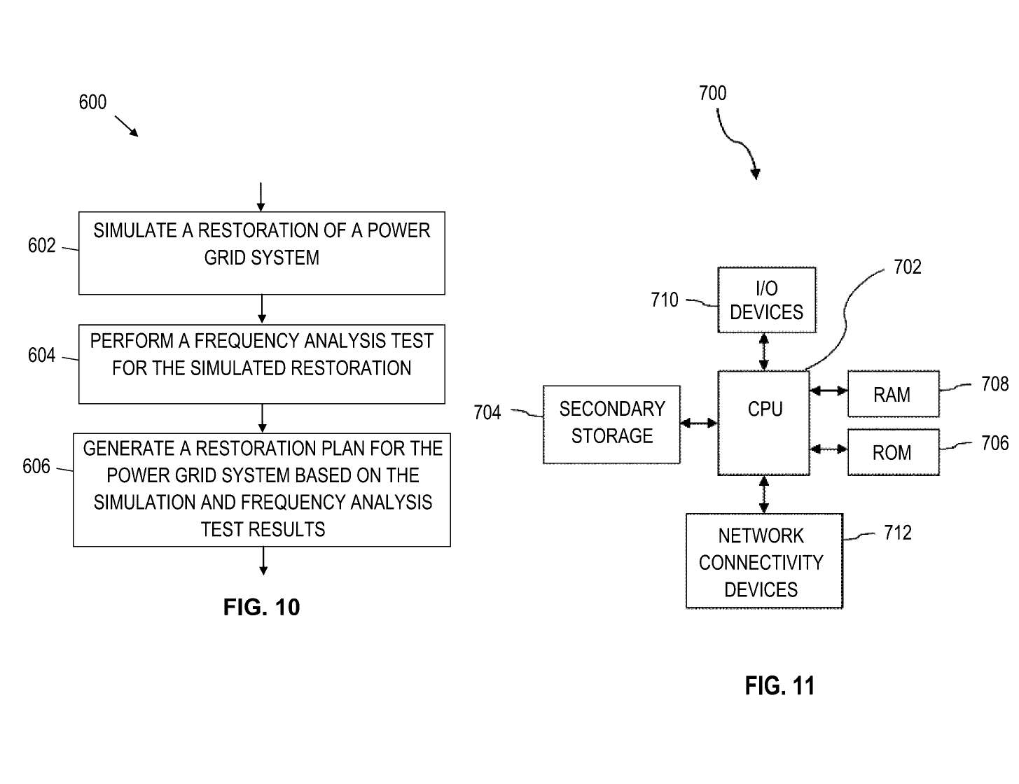

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### NOTATION AND NOMENCLATURE

Certain terms are used throughout the following description and claims to refer to particular system components. As one skilled in the art will appreciate, individuals and organizations may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to computer-based power restoration planning tools, including power restoration simulation and a frequency analysis test function. In at least some embodiments, power restoration simulation and planning software is executed by one or more computers. As an example, a computer executing power restoration simulation and planning software may be part of or may be in communication with an electrical grid control system. In such case, results of a power restoration simulation, including frequency analysis test results, may be used to program or otherwise select options for power restoration of an electrical grid in the event of a power outage.

In at least some embodiments, power restoration simulation and planning software features may be available via a website. For example, a client-server system may be provided to enable an electrical grid entity or service provider to download or access power restoration simulation and planning software. In one example client-server system scenario, a server computer receives a request from a client computer. The request includes or enables a transfer of information related to a particular electrical grid and power restoration scenario. With the information corresponding to the particular scenario, the server computer is able to process the request and simulate power restoration. As part of the power restoration simulation, a frequency analysis test function is performed. Once completed, the server computer sends simulation results, including frequency analysis test results, back to the client computer. The simulation results may include, for example, a restoration plan along with relevant test information such as frequency analysis test warnings and related frequency values. An electrical grid entity or service provider may use the simulation results to make decisions or plans for restoring power to an electrical grid after a power outage. Further, the simulation results may guide electrical grid modifications performed by electrical grid entity or service provider. Example electrical grid modifications include adding components (e.g., generators, loads, shunts, branches, or buses), removing components, and/or providing different connection options between components.

It should be appreciated that the power restoration simulation operations described herein, including the frequency analysis test function, may be performed by one or more computers. Such computers may be stand-alone computers, networked computers, and/or computers in a client-server relationship. To execute power restoration simulation software, a computer receives and installs a copy of the software (via download or other distribution). Once installed, the power restoration simulation software enables some or all functions, including the frequency analysis test function described herein. An example power restoration simulation software version provides a user interface that enables an end-user to select or provide a file that describes a particular electrical grid and power restoration scenario. Alternatively, electrical grid and power restoration scenario details may be selected from a menu of options. The user interface also enables an end-user to select test options, including frequency analysis test options. The test results for the particular power restoration simulation may be displayed via a computer monitor and/or a related report (a file or printout) is generated for storage or later analysis. As desired, different electrical grid and power restoration scenarios can be created and tested. The results of different scenarios can be compared and used to guide power restoration and/or electrical grid planning operations of an electrical grid entity or service provider.

In at least some embodiments, the disclosed power restoration simulation and planning software involves four steps: 1) sectionalization; 2) generator restoration; 3) load restoration; 4) and synchronization. For more information regarding power restoration simulation including the above steps, reference may be had to U.S. Pat. App. Pub. No. 2013/0346057 A1, entitled “Methods and Systems for Power Restoration Planning” and filed Jun. 26, 2012. The disclosed frequency analysis test functions described herein are applicable, in at least some embodiments, to corresponding load restoration and/or synchronization steps of a power restoration simulation process.

As a specific example, a frequency analysis test may involve three processes: model selection, parameter estimation, and frequency calculation. In the model selection process, various models used for frequency analysis are selected and/or created. Example models used for the frequency analysis test include a generator model, a governor model, and/or a cold load model. In at least some embodiments, one or more models used for the frequency analysis test described herein correspond to simplified or reduced models that approximate a respective conventional model (with improved efficiency). In the parameter estimation process, the value of one or more parameters used with one or more models obtained from the model selection process is estimated. As an example, a time constant used with a governor model may be estimated during the parameter estimation process. In at least some embodiments, this time constant is estimated from the solution of a non-linear multi-objective optimization function. In the frequency calculation process, a frequency analysis is performed using one or more models obtained from the model selection process and one or more estimated parameters obtained from the parameter estimation process. In at least some embodiments, the frequency calculation process involves operating modes on the generators and loads for a typical restoration analysis will be considered. The response of average system frequency for a cold load pick up will be simulated and analyzed in this process. Several assumptions and simplifications are made to improve the efficiency of this process. With the frequency analysis test, the impact of in-rush current of cold loads on the frequency response of a system during power restoration can be evaluated.

In at least some embodiments, a user interface enables an end-user to select frequency analysis test options. As an example, an end-user may edit model parameters such as generator inertia and damping, governor droop constant, peak value and final steady state value of the cold load. Further, the user interface may enable an end-user to select a frequency threshold for the frequency analysis test. The frequency threshold may be used to trigger display of warnings, frequency values, and/or other frequency analysis test results. Further, the user interface may enable an end-user to select a governor response file (e.g., to estimate the time constant in the governor model used in the frequency test model). Further, an end-user may select different types of governor model to be used in the frequency analysis.

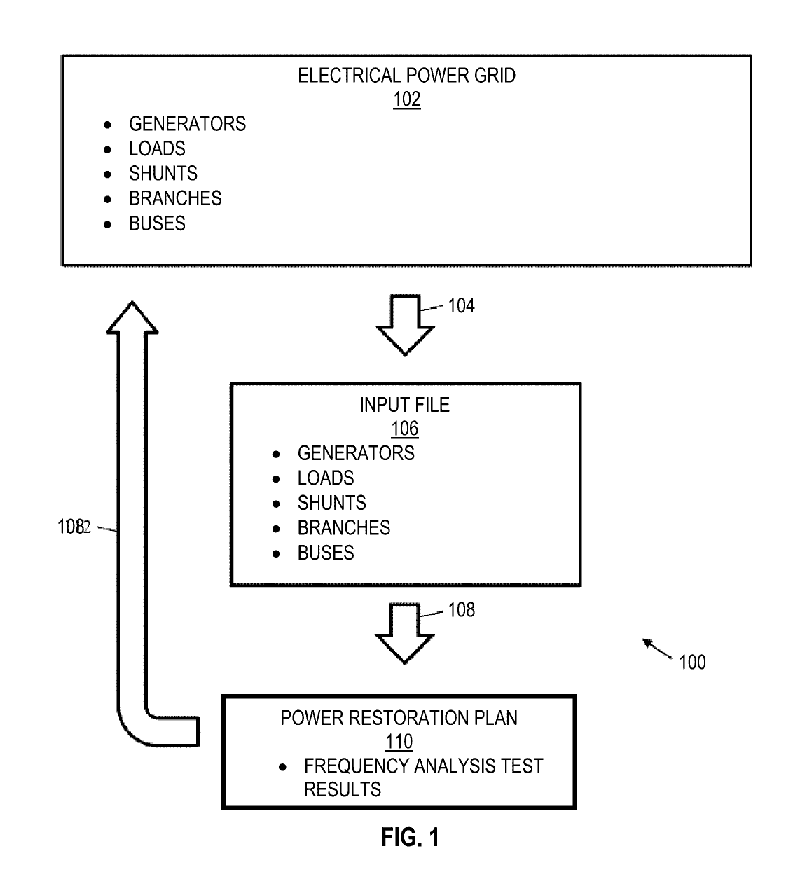

FIG. 1 illustrates a power restoration planning environment 100 in accordance with an embodiment of the disclosure. As shown, the environment 100 comprises an electronic power grid 102 comprising generators, loads, shunts, branches, and/or buses. A translation step 104 is applied to prepare an input file 106 that represents the electrical power grid 102. For example, the input file 106 may comprise a list or table of generators, loads, shunts, branches, and/or buses and their respective parameters in accordance with the components of the electrical power grid 102. In at least some embodiments, the translation step 104 involves entering data to describe an electrical power grid topology using software that may or may not be part of the power restoration and planning software described herein. A power restoration simulation step 108, including a frequency analysis test function, is then applied to the electrical power grid topology represented by the input file 106 to determine a power restoration plan 110. The power restoration plan 110 may be applied at step 112 to restore power to the electrical power grid 102. In some embodiments, the power restoration plan 110 is generated in response to a power outage. Alternatively, the power restoration plan 110 is generated before a power outage for use in restoring power to the electrical power grid 102 when needed.

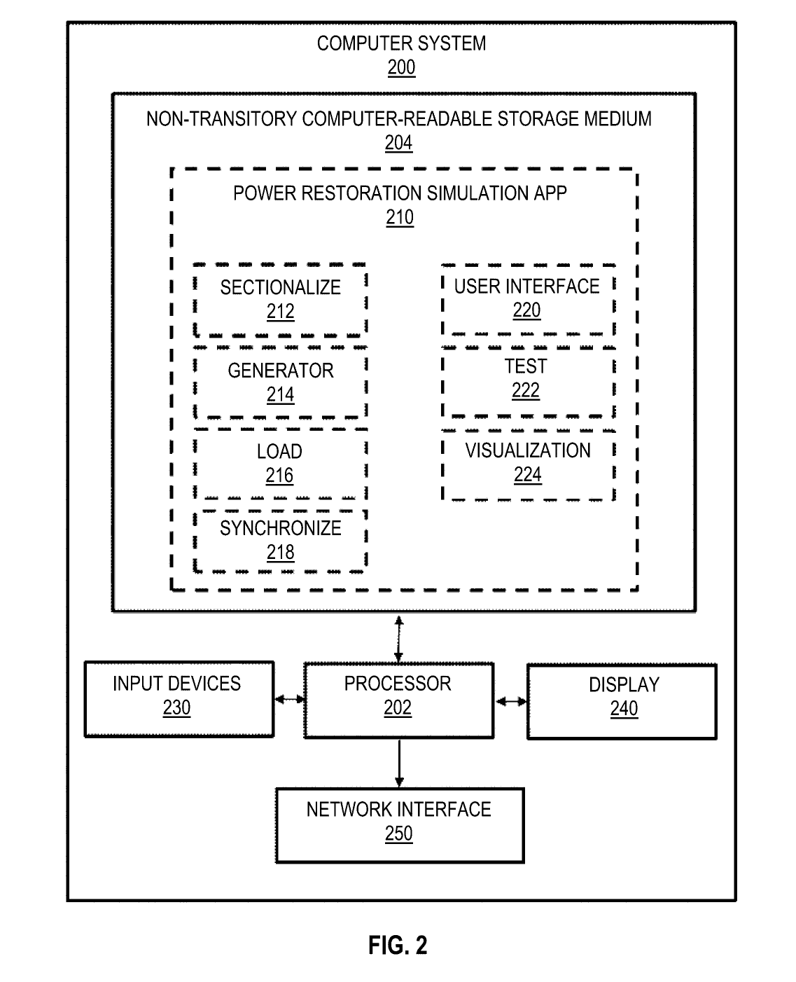

FIG. 2 illustrates a computer system 200 in accordance with an embodiment of the disclosure. The computer system 200 may correspond to, for example, a computer in the form of a mobile device, a tablet computer, a laptop computer, a desktop computer, or a server computer. As shown, the computer system 200 comprises a processor 202 coupled to a non-transitory computer readable storage 204 storing a power restoration simulation application 210. The computer system 200 may also comprise a network interface 250 coupled to the processor 202. Further, in at least some embodiments, the computer system 200 comprises input devices 230 and a display 240 coupled to the processor 202.

The processor 202 of the computer system 200 is configured to execute instructions stored by the non-transitory computer readable storage 204. The processor 202 may be, for example, a general-purpose processor, a digital signal processor, a microcontroller, etc. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. In operation, the processor 202 executes instructions, codes, computer programs, scripts which it accesses from hard disk, floppy disk, optical disk (these various disk based systems may all be considered secondary storage), read-only memory (ROM), random access memory (RAM), the network interface 250, or the input devices 230. While only one processor 202 is shown, multiple processors may be present. Thus, while instructions may be discussed as executed by a processor, the instructions may be executed simultaneously, serially, or otherwise executed by one or multiple processors.

The non-transitory computer readable storage 204 corresponds, for example, to random access memory (RAM), which stores programs and/or data structures during runtime of the computer system 200. For example, during runtime of the computer system 200, the non-transitory computer readable storage 204 may store the power restoration simulation application 210 for execution by the processor 202 to perform the power restoration simulation, including frequency analysis test operations as described herein. The power restoration simulation application 210 may be distributed to the computer system 200 via a network connection or via a local storage device corresponding to any combination of non-volatile memories such as semiconductor memory (e.g., flash memory), magnetic storage (e.g., a hard drive, tape drive, etc.), optical storage (e.g., compact disc or digital versatile disc), etc. Regardless the manner in which the power restoration simulation application 210 is distributed to the computer system 200, the code and/or data structures corresponding to the power restoration simulation 210 are loaded into the non-transitory computer readable storage 204 for execution by the processor 202.

The network interface 250 may couple to the processor 202 to enable the processor 202 to communicate with network devices. In different embodiments, the network interface 250 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The network interface 250 may enable the processor 202 to communicate with the Internet or one or more intranets.

As an example, for a stand-alone computing scenario, the network interface 250 may enable the computer system 200 to download a stand-alone version of the power restoration simulation application 210. Once downloaded, the power restoration simulation application 210 enables stand-alone operations and user-interface options related to performing power restoration simulation and providing corresponding power restoration plans including frequency analysis test results. For a client-computing scenario, the network interface 250 may enable the computer system 200 to download a client-side version of the power restoration simulation application 210. Once downloaded, the power restoration simulation application 210 enables client-side operations and user-interface options related to submitting power restoration simulation requests and receiving corresponding power restoration plans including frequency analysis test results. Another example of client-side operations may include submitting a request to store or access previously submitted power restoration simulation requests and corresponding power restoration plans with frequency analysis test results. For a server-computing scenario, the network interface 250 may enable the computer system 200 to download a server-side version of the power restoration simulation application 210. Once downloaded, the power restoration simulation application 210 enables server-side operations related to receiving power restoration simulation requests and providing corresponding power restoration plans including frequency analysis test results. Another example of server-side operations includes providing a power restoration plan with frequency analysis test results in response to a request to access results of previously submitted power restoration simulation request.

The input devices 230 may comprise various types of input devices for selection of data or for inputting of data to the computer system 200. As an example, the input devices 230 may correspond to a touch screen, a key pad, a keyboard, a cursor controller, or other input devices. It should be appreciated that input devices 230 need not be included for all computer system variations (e.g., some server embodiments may not include input devices 230). Further, while not shown, it should be appreciated that the computer system 200 may also include output devices such as printers to provide a print-out of power restoration simulation results including frequency analysis results.

In accordance with at least some embodiments, the power restoration simulation application 210 comprises a sectionalize module 212, a generator module 214, a load module 216, and a synchronize module 220 to support power restoration planning as described herein. Further, the power restoration simulation application 210 comprises a user interface 220, a test module 222, and a visualization module 224.

The sectionalize module 212 performs sectionalize operations for a power restoration simulation scenario. The generator module 214 performs generator restoration operations for a power restoration simulation scenario. The load module 216 performs load restoration operations for a power restoration simulation scenario. The synchronize module 218 performs synchronize operations for a power restoration simulation scenario. Further, the user interface 220 enables a user to select an input file or to otherwise provide input parameters for the power restoration simulation application 210. Further, the test module 222 provides power restoration plan testing operations, including the frequency analysis operations described herein. The visualization module 224 operates to display simulation options, power restoration plans, or related data to a user.

In at least some embodiments, the operations of the power restoration simulation application 210 involve an undirected graph G=(N, A) model, where N represents the node set and A represents the arc set. The node set is defined as N={n₁, . . . , nₖ}=G∪L∪X, where G={g₁, . . . , gₘ} is the set of generator buses, L={l₁, . . . , lᵣ} is the set of load buses, and X is the set of other buses without any sources. BSεG is the black-start generator bus set. The arc set is defined as A={(a₁^{l}, a₂^{l}), . . . , (a₁^{q}, a₂^{q})}=BUT, where B represents the set of transmission lines and T represents the set of transformers.

The objective function can be formulated to maximize the number of generators in service during power system restoration periods without violating system constraints. In at least some embodiments, three steady-state criteria are used to validate the restoration plan. These criteria are voltage constraint, line flow constraint, and generator output constraint.

Assuming the system has k total buses with m generators and q branches, the restoration problem is the solution for the following Integer Programming (IP) problem.

$$max {\sum }_{i = 1}^{T} ( {\sum }_{i = 1}^{m} {u}_{gi}^{t} + {\sum }_{i = 1}^{r} {u}_{{l}_{i}}^{t} + {\sum }_{i = 1}^{q} {u}_{{a}_{i}}^{t} )$$

$$s . t . \{ \begin{matrix}{V}_{{n}_{j }}^{m i n} \leq {V}_{{n}_{j}}^{t} \leq {V}_{{n}_{j}}^{ma x} , & j = 1 , … , k \\ {S}_{{a}_{i}}^{t} \leq {S}_{{a}_{i}}^{ma x} , & i = 1 , … , q \\ {P}_{{g}_{i}}^{m i n} \leq {P}_{{g}_{i}}^{t} \leq {P}_{{g}_{i}}^{ma x} , & i = 1 , … , m\end{matrix}$$

where u_{g}_{ᵢ}^{t} and uₗ_{ᵢ}^{t} are binary decision variables denoted as the status of generator gᵢ at time t, the status of load lᵢ, and the status of branch aᵢ. For example, uᵢ^{t}=1 means that generator i is energized at time t and uᵢ^{t}=0 means it is off at time t. This formulation also applies to uₗ_{ᵢ}^{t} and uₐ_{ᵢ}^{t}, for loads and branches. Vₙ_{ⱼ}^{t} is the voltage of bus nⱼ at time t, where Vₙ_{ⱼ}^{min} and Vₙ_{ⱼ}^{max} represent the minimum and maximum allowable value of bus voltage respectively; Sₐ_{ᵢ}^{t} is the complex power flow in branch aᵢ at time t and Sₐ_{ᵢ}^{max} is the corresponding power flow limit; P_{g}_{ᵢ}^{t} is the real power output of generator gᵢ at time t, where P_{g}_{ᵢ}^{min} and P_{g}_{ᵢ}^{max} are minimum and maximum real power outputs of generator gᵢ.

In accordance with at least some embodiments, the test module 222 of power restoration simulation application 210 employs various models to perform a frequency analysis test function as described herein. Conceptually, the frequency dynamics of a power system can be analogized as a dynamic system of suspended masses interconnected by elastic strings (i.e., generators and motors correspond to the masses, while transmission lines correspond to the elastic strings). In normal operation, the dynamic system is in a static steady state with each elastic string loaded below its static limit. However, when one external force or disturbance appears in the dynamic system (e.g., representing a change of load), the system experiences oscillations before a new steady state is reached. This oscillatory behavior and the balance between total input and output powers is expressed as follows,

$$\frac{d ( {ω}_{i} - {ω}_{s} )}{d t} = \frac{1}{2 {H}_{i}} ( {P}_{{mech}_{i}} - {P}_{{elec}_{i}} ) \\ \frac{d f}{d t} = \frac{\sum {P}_{{mech}_{i}} - \sum {P}_{{elec}_{i}}}{2 \sum {H}_{i}} , \qquad Equation ( 1 )$$

where H is an inertia constant, P_{mech}_{ᵢ} is a mechanical power input, P_{elec}_{ᵢ}, is an electrical power output, ωᵢ is a rotational generator speed (rad/sec), ωₛ is a rotational rated speed (rad/sec), and f is a system frequency (per unit or “pu”). In Equation 1, any unbalance between production and consumption results in a change in the kinetic energy of the rotating mass and thus in a change in frequency.

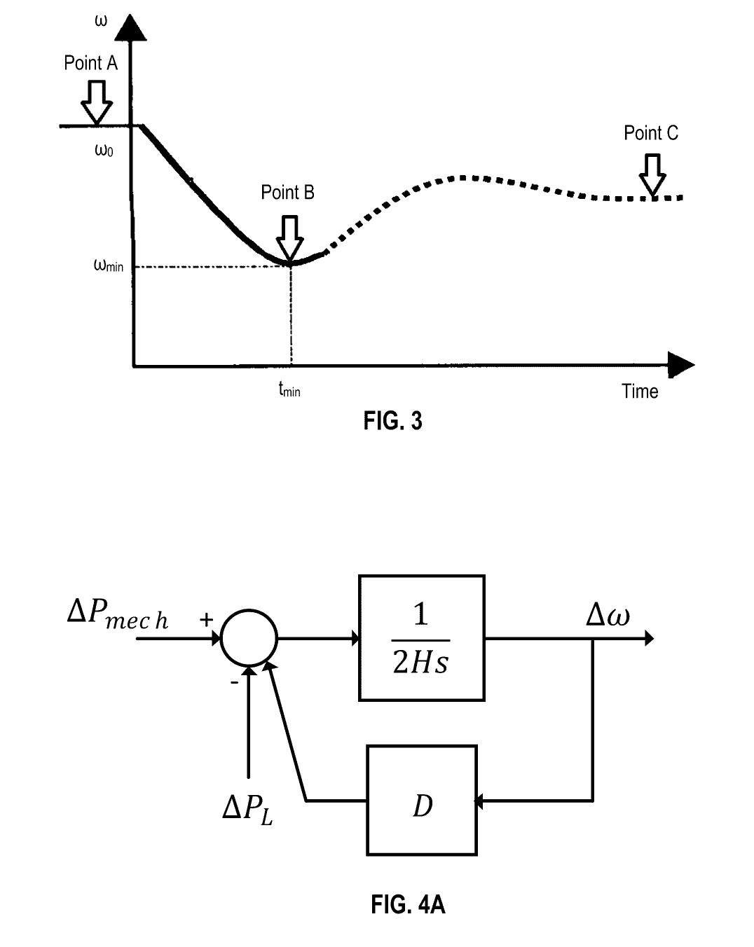

The frequency response to load pick up can be divided in three zones: an arresting period; a rebound period, and a recovery period. FIG. 3 shows an example frequency response. In at least some embodiments, the frequency analysis test described herein evaluates the average frequency response during the arresting and rebound periods of the frequency curve, where these average frequency responses are a function of the primary frequency control and the droop governor response. In at least some embodiments, the frequency analysis test identifies the minimum frequency (corresponding to point B) and the settling frequency (corresponding point C) for each stage of power restoration.

In normal operation the balance between electrical and mechanical powers results in non-acceleration; however, when the speed changes result of a power variation, the power imbalance in the unit takes the form of:

Pₙₑₜ=P_{mech}−P_{elec}, Equation (2)

where Pₙₑₜ is the net acceleration power, P_{mech} is the mechanical power input in the unit, and P_{elec} is the electrical power output in the unit. Also, the net acceleration power after a disturbance follows:

$$Δ {P}_{net} = Δ {P}_{mech} - Δ {P}_{elec} = 2 H \frac{d ( Δ ω )}{d t} . \qquad Equation ( 3 )$$

In Laplace domain, Equation 3 can be expressed as:

ΔPₙₑₜ(s)=ΔP_{mech}(s)−ΔP_{elec}(s)=2HsΔω(s), Equation (4)

where H is an inertia constant, ΔPₙₑₜ is a net power variation, ΔP_{mech} is a mechanical power variation, ΔP_{elec} is an electrical power variation, and Δω is a generator speed variation. If damping D in the generator and load frequency dependency is considered, Equation 4 satisfies:

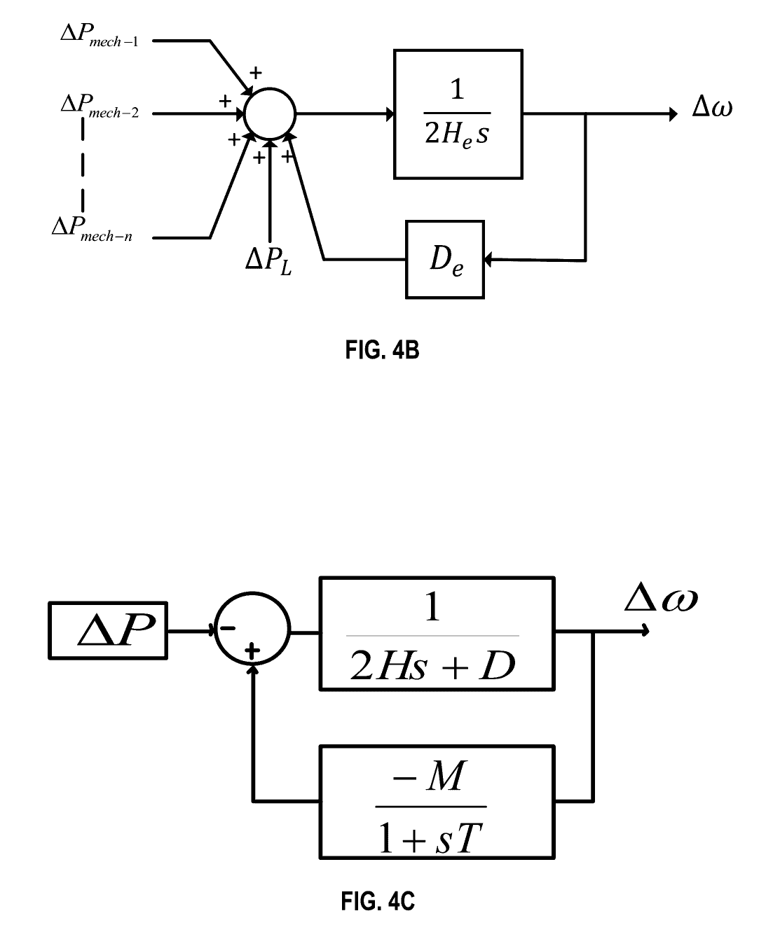

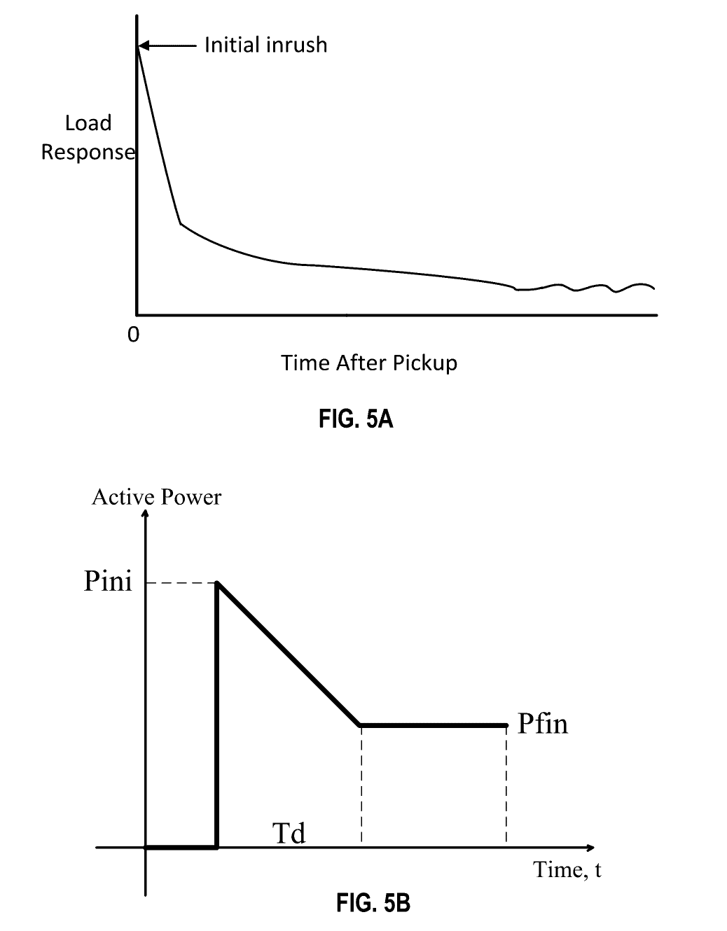

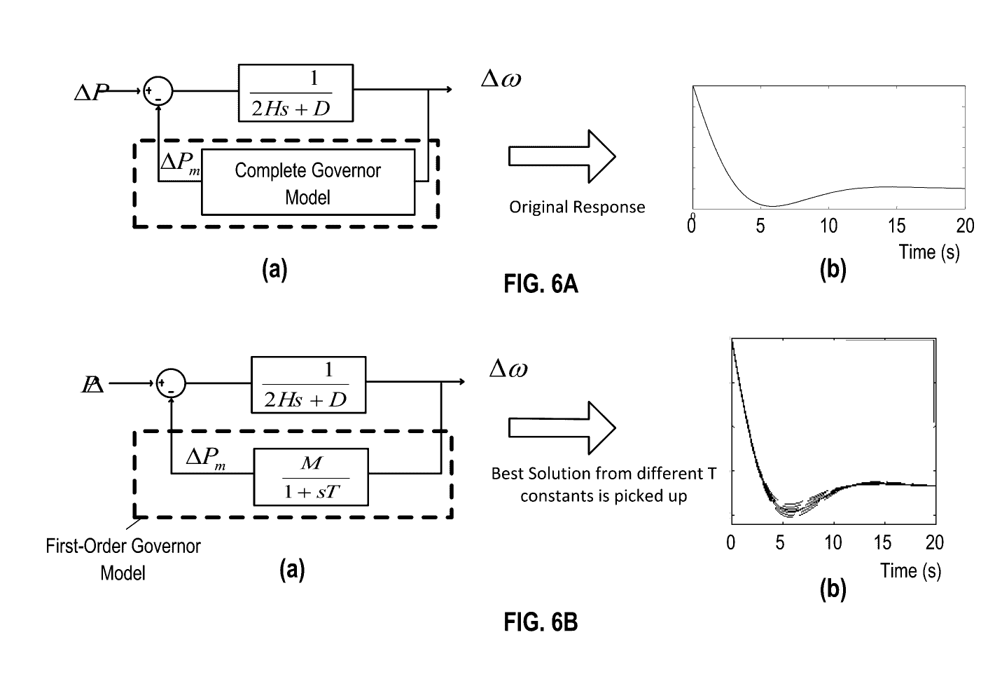

ΔP_{mech}(s)−ΔP_{elec}(s)==(2Hs+D)Δω(s), Equation (5)

where the corresponding model is represented in FIG. 4A.

If more than one generator appears in the system and a uniform frequency value through the system that ignores any inter-generator oscillation is assumed, then the aggregated generator system model is represented in FIG. 4B. In the aggregated generator system model of FIG. 4B, the total lumped system's inertia Hₑ is the sum of all generators' inertia in the system, and the equivalent generators and load damping Dₑ represents the sum of the entire damped characteristic in the system.

The dynamic models for different kinds of governor (steam, gas, hydro turbines) are well developed and represented in many literatures. Example governor models include a general model for a steam turbine speed governing system, the IEESGO standard model, and the GAST gas turbine governor model. For more information regarding governor models, reference may be had to F. P. de Mello and D J Ahner, “Dynamic models for combined cycle plants in power system studies”, IEEE Transaction on Power Systems, vol. 9, pp. 1698-1708 (1994), and I. C. Report, “Dynamic models for steam and hydro turbines in power system studies”, IEEE Transaction on Power Apparatus and Systems, vol. PAS-92, pp. 1904-1915 (1973).

In general, complete governor models are complicated due to nonlinear elements and/or other complexities. Therefore, in at least some embodiments, the test module 222 performs a frequency analysis test function using a simplified or reduced governor model to reduce the amount of computational effort needed to obtain a solution. As an example, the reduced governor model employed by the test module 222 may capture the main dynamic behavior of the average system's frequency during the first instances of frequency evolution. More specifically, the reduced governor model may represent a complete turbine-governor with a linear first-order transfer function dominated by only two parameters: a gain (M) that represents the inverse of the droop constant in the complete governor model and a time constant (T). A single generator with a reduced first order governor model is shown in FIG. 4C. For the first-order governor model, M can be obtained from system operators directly and the only unknown parameter is T. A description of how T can be estimated is presented later.

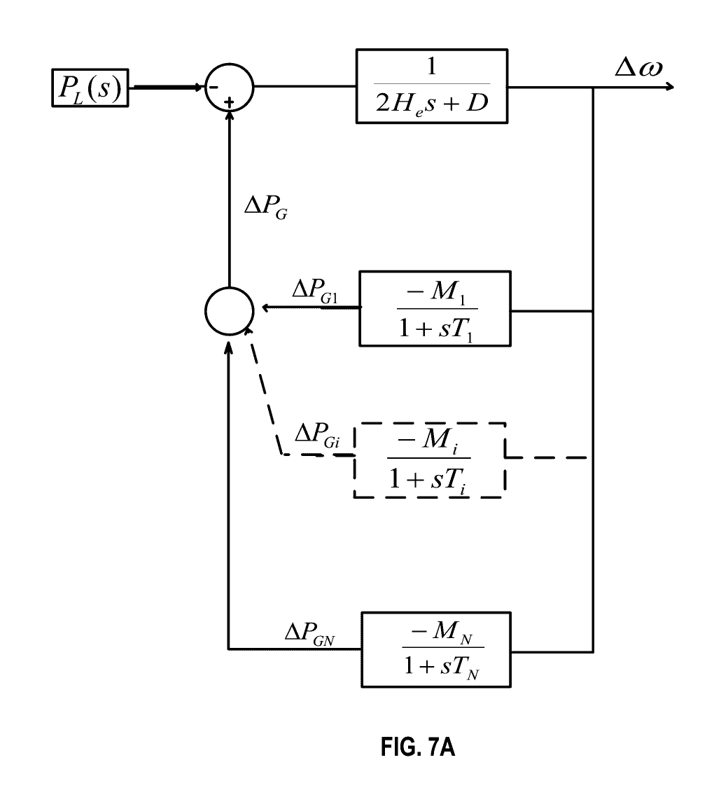

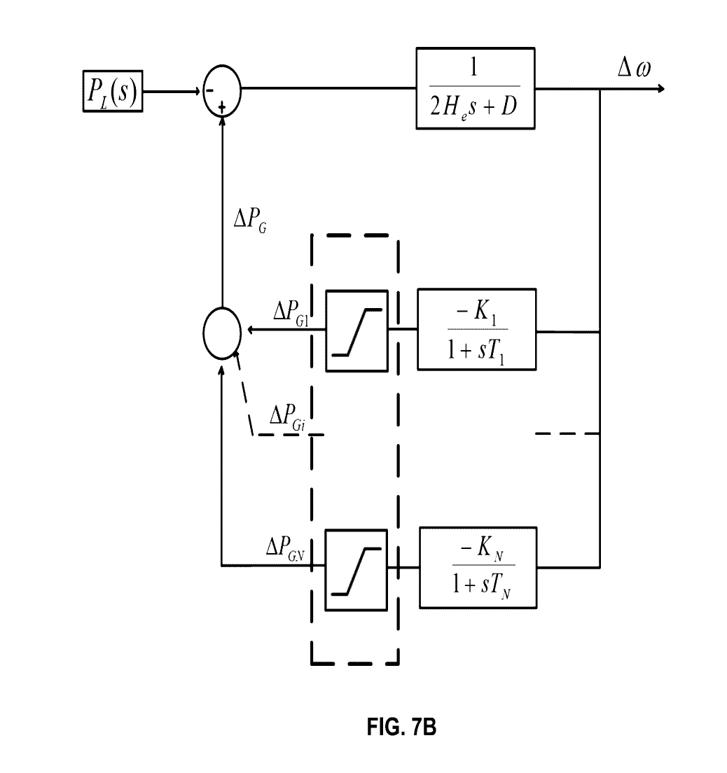

After long periods of outage, certain loads exhibit large overshoots during their re-connection. Those power peaks are followed by ramping down values before they reach a steady state. Air conditioners, refrigerators and motors are some of the devices that produce this kind of behavior in a power system. Initially, such devices present high inrush currents (8-15 times the rated magnitude) due to the initial torque, and seconds later such device reaches a new steady state. FIG. 5A shows an example load response for the duration and magnitude of the inrush phenomenon.

In at least some embodiments, the test module 222 of power restoration simulation application 210 employs a simplified cold load model as follows:

$${P}_{L} = \{ \begin{matrix}0 & t < {t}_{0} \\ {P}_{ini} - \{ \frac{( {P}_{ini} - {P}_{fin} ) ( t - {t}_{0} )}{{T}_{d}} \} & {t}_{0} \leq t \leq {T}_{d } \\ {P}_{fin} & t \geq {t}_{0} + {T}_{d}\end{matrix} , \qquad Equation ( 6 )$$

where t₀ is the time at which cold load begins, Pᵢₙᵢ is a peak value for the cold load (pu), P_{fin} is a final steady state value of the cold load (pu), and T_{d} is a time interval of real power decay. The model corresponding to Equation 6 presents an initial high inrush current with a linear decreasing power rate, and a final steady state. The inrush characteristic of this simplified cold load model is shown in FIG. 5B. As shown in FIG. 5B, this simplified model can capture most of the inrush cold load characteristics during the first instances of frequency decrease.

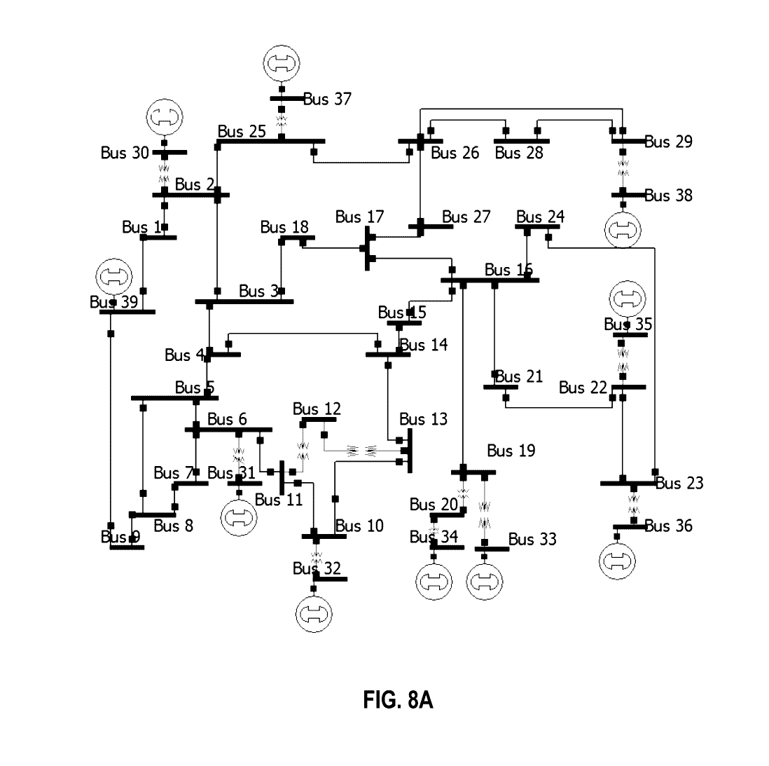

The process for estimating T used in the first-order governor model may include multiple steps. In at least some embodiments, a two-part frequency response analysis is performed. In the first part of the frequency response analysis, each generator is isolated from the system and a small disturbance (e.g., 1% active power of the system's base) is introduced at the terminal bus of each generator using a complete governor model to obtain a corresponding frequency response. FIG. 6A represents the first part of the frequency response analysis, where part (a) of FIG. 6A shows a generator model with a feedback loop that includes a complete governor model, and where part (b) of FIG. 6A shows a corresponding frequency response. In the second part of the frequency response analysis, the value of T is estimated by solving a non-linear multi-objective optimization problem, where the solution is intended to provide a value of T resulting in a frequency response that most closely resembles the frequency response obtained using a complete governor model. FIG. 6B represents the second part of the frequency response analysis, where part (a) of FIG. 6B shows a generator model with a feedback loop that includes a first-order governor model, and where part (b) of FIG. 6B shows multiple frequency responses that vary as a function of T, and where a best solution is selected.

In at least some embodiments, the multi-objective optimization problem used to estimate T is represented as:

$${min}_{T} {Z}_{1} \vert {ω}_{m i n} ( T ) - {ω}_{m i n}^{*} \vert + {Z}_{2} \vert {ω}_{slope} ( T ) - {ω}_{slope}^{*} \vert + {Z}_{3} \vert {t}_{m i n} ( T ) - {t}_{m i n}^{*} \vert + {Z}_{4} \vert {ω}_{ss} ( T ) - {ω}_{ss}^{*} \vert . \qquad Equation ( 7 )$$

In Equation 7, the first term (i.e., |ωₘᵢₙ(T)−ωₘᵢₙ*|) represents the error for the minimum frequency (i.e., the difference between the first-order governor model estimate of the minimum frequency and the complete governor model value) following a small LP disturbance, the second term (i.e., |ωₛₗₒₚₑ(T)−ωₛₗₒₚₑ*|) represents the error for the initial slope of the frequency response (i.e., the difference between the first-order governor model estimate of the initial slope and the complete governor model value), the third term (i.e., |tₘᵢₙ(T)−tₘᵢₙ*|) represents the error for the time to reach the minimum frequency (i.e., the difference between the first-order governor model estimate of the minimum frequency and the complete governor model value), and the fourth term (i.e., |ωₛₛ(T)−ωₛₛ*|) represents the error for the steady state frequency (i.e., the difference between the first-order governor model estimate of the steady state frequency and the complete governor model value). Further, different weights (Z₁, Z₂, Z₃ and Z₄) can be applied to each of the terms. The minimum frequency (in the first term), determines the maximum load pick up during each restoration step. The initial slope (in the second term) enables setting of under frequency load shedding relays and in combination with tₘᵢₙ (in the third term) provides a fast approximation for the minimum system's frequency following a ΔP load change. Finally, the steady state frequency deviation (in the fourth term) shows the final frequency mismatch after a load pick up. In at least some embodiments, the minimum frequency point reached during the first frequency decreasing period is given highest priority, and the weights for Equation 7 follow the condition Z₄<Z₃<Z, <Z₁. Many existing methods that can be used to solve the above multi-objective optimization problem represented by Equation 7. Example methods include K. Deb, A. Pratap, S. Agarwal and T. Meyarivan, “A fast and elitist multi-objective genetic algorithm: NSGA-II”, IEEE Transaction on Evolutionary Computation, vol. 6, pp 182-197 (2002).

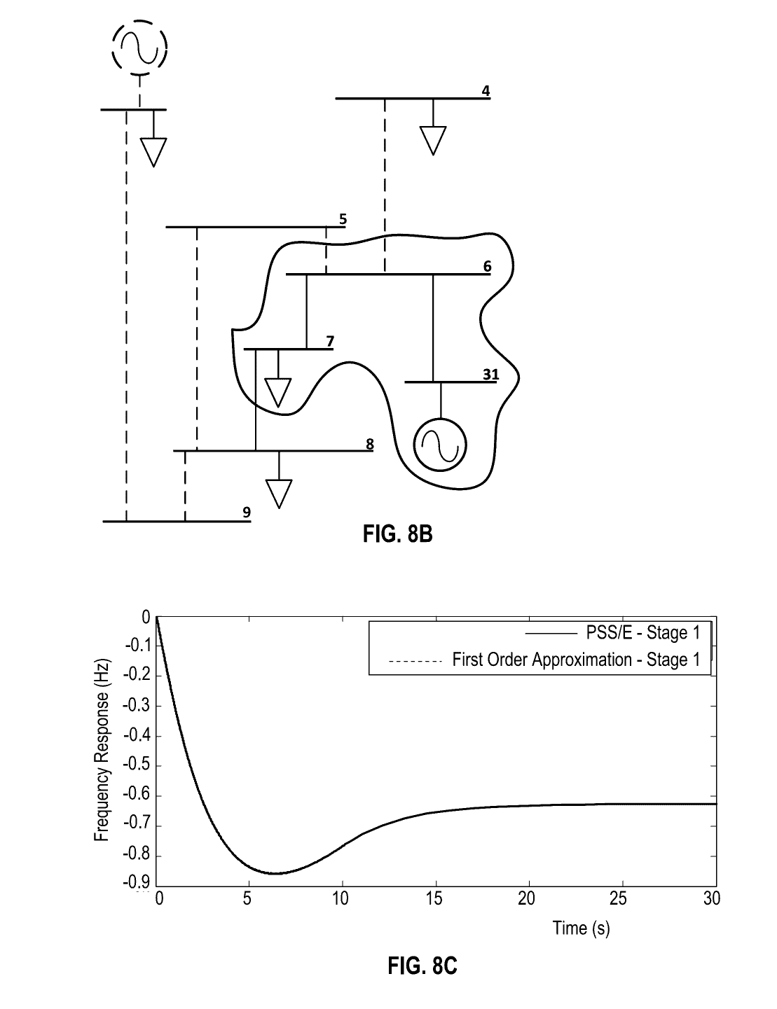

The complete system model for fast frequency computation including the previously-discussed aggregated generator model, first-order governor model, and simplified cold load model is represented in FIG. 7A. In the complete system model, the forward loop is the aggregated generator model and feedback loops include simplified first-order governor models for each unit. Further, P_{L} is the varying cold load values used as the input to the system model, and Δω is the system frequency to be calculated. The complete system model is represented by the following dynamic equations:

$$\begin{matrix}\frac{d Δ ω}{d t} = \frac{1}{2 {H}_{e}} ( Δ {P}_{G} - {P}_{L} - D Δ ω ) ; & Equation ( 8 ) \\ \frac{d Δ {P}_{Gi}}{d t} = - \frac{1}{{T}_{i}} ( Δ {P}_{Gi} + {M}_{i} Δ ω ) ; & Equation ( 9 ) \\ {P}_{G} = {\sum }_{i = 1}^{N} Δ {P}_{Gi} ; and & Equation ( 10 ) \\ {P}_{L} = \{ \begin{matrix}0 & t < {t}_{0} \\ {P}_{ini} - \{ \frac{( {P}_{ini} - {P}_{fin} ) ( t - {t}_{0} )}{{T}_{d}} \} & {t}_{0} \leq t \leq {T}_{d} \\ {P}_{fin} & t \geq {t}_{0} + {T}_{d}\end{matrix} . & Equation ( 11 )\end{matrix}$$

Further, if governor limits are considered, the following equation can be used for those units that reach the limit:

$$Δ {P}_{Gi} = Δ {P}_{{gov}_{ma x }} = {P}_{{gov}_{ma x }} - {P}_{gov}^{0} , \qquad Equation ( 12 )$$

where

$${P}_{{gov}_{ma x}}$$

is the maximum governor output, and P_{gov}⁰ is the initial governor output. In at least some embodiments, P_{gov}⁰ is obtained from the steady state power flow in the previous restoration stage. The complete system model with saturation elements is represented in FIG. 7B. Accordingly, in at least some embodiments, the test module 222 solves Equations 8-12 to calculate the system frequency response Δω(t), and to obtain corresponding values for the minimum frequency, the settling frequency, and the initial frequency slope.

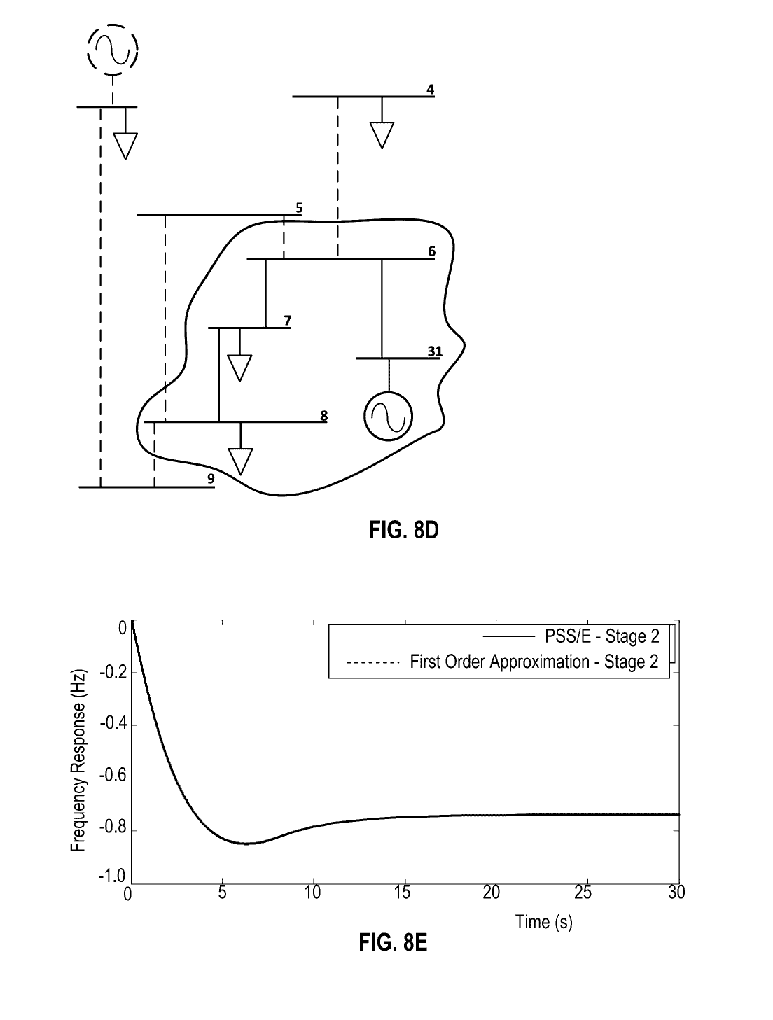

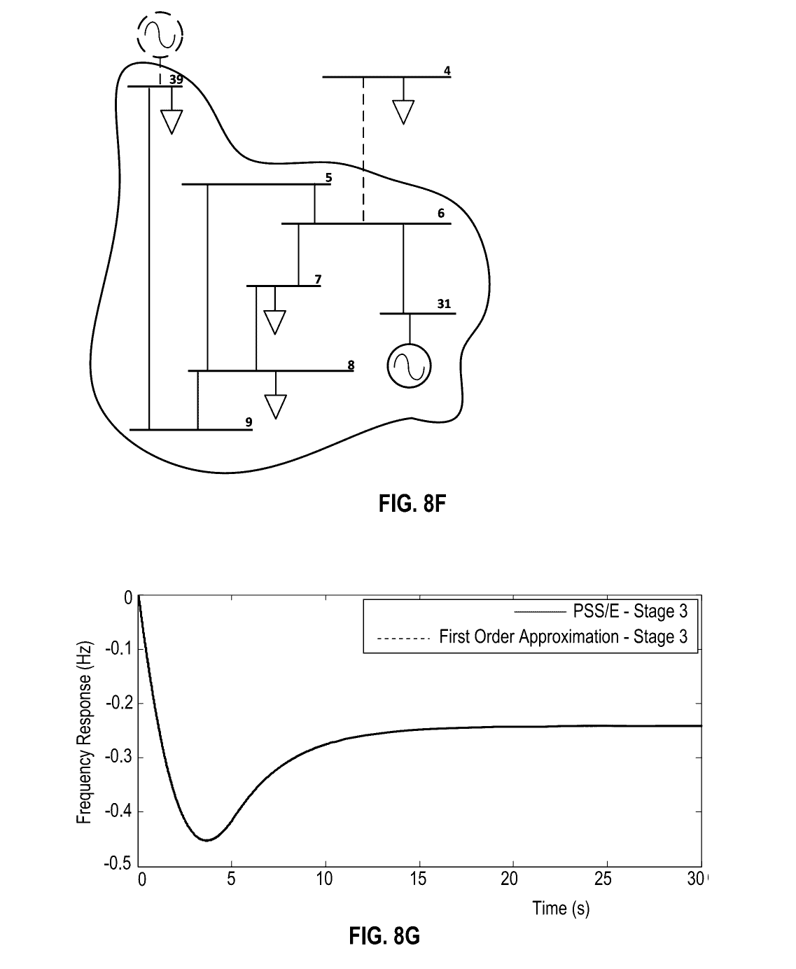

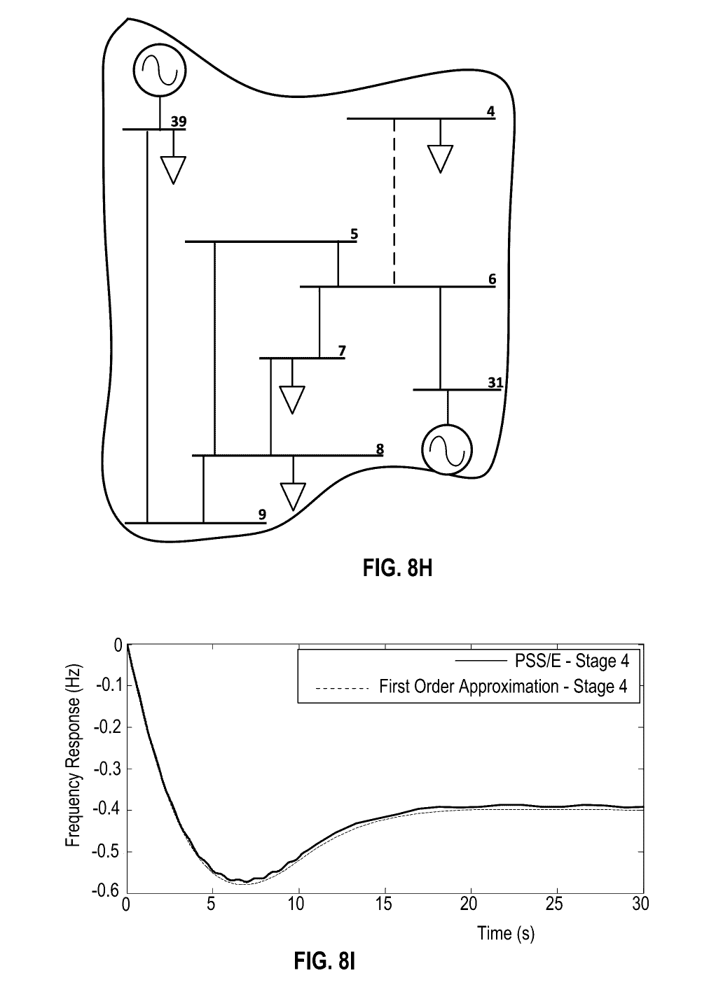

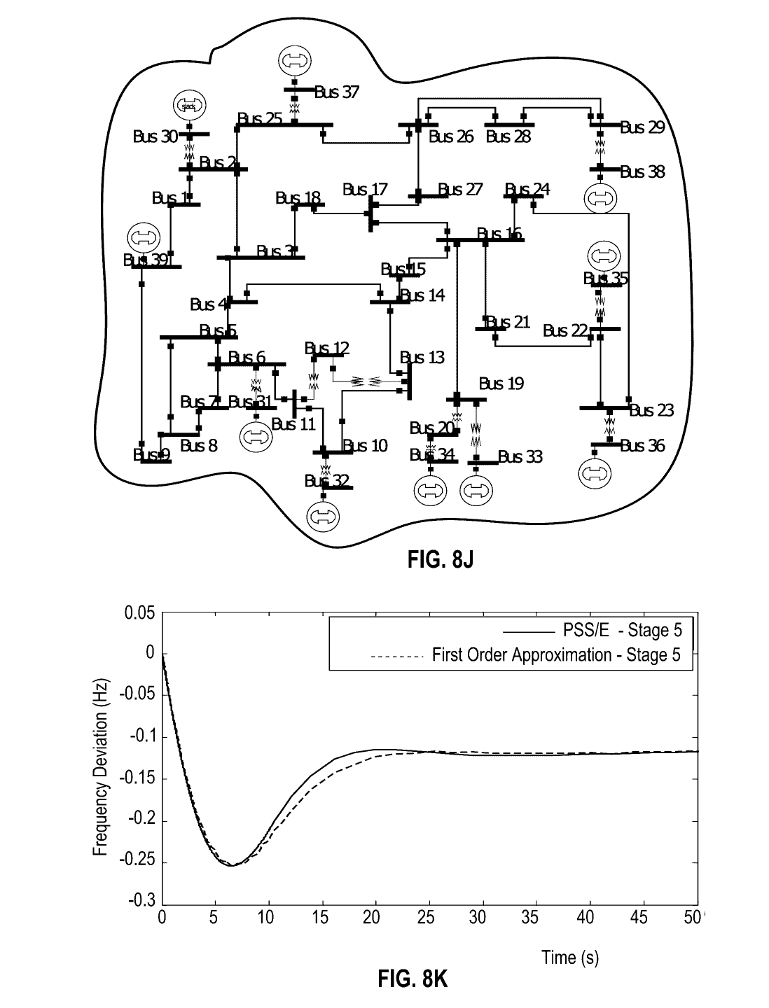

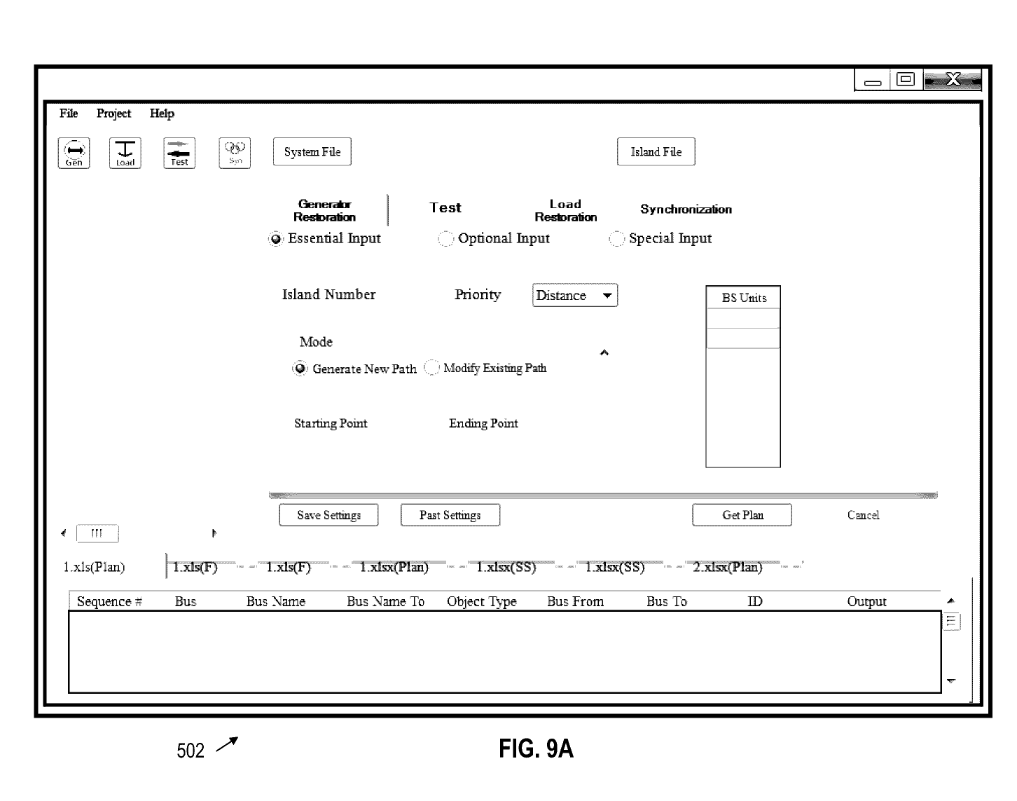

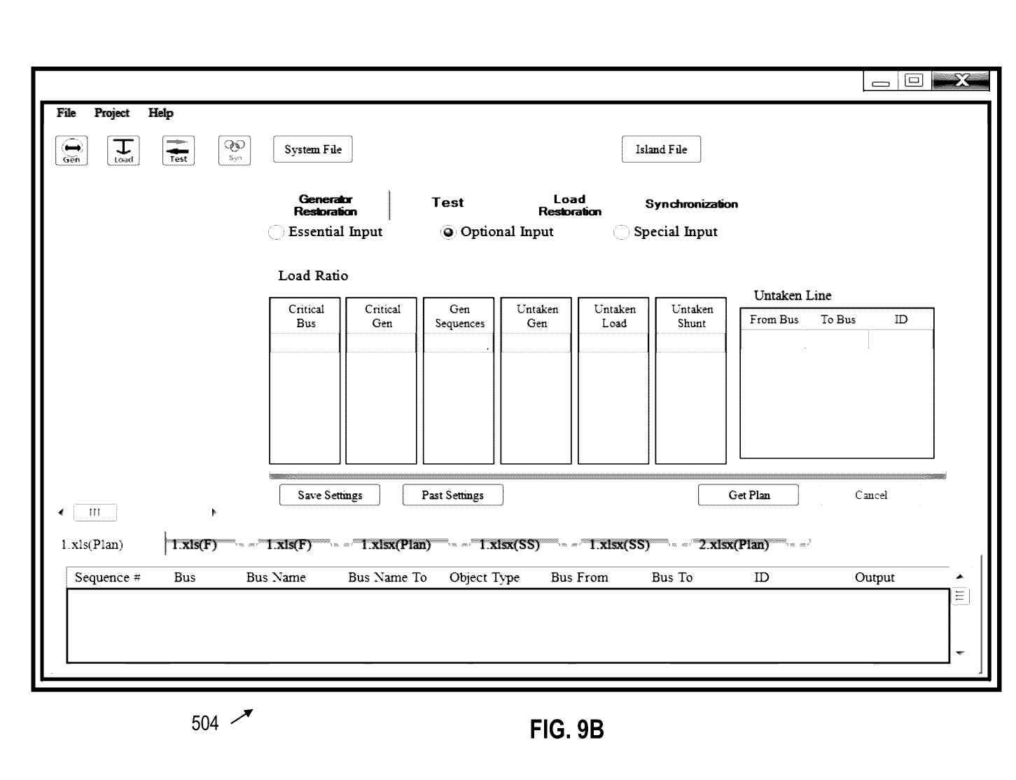

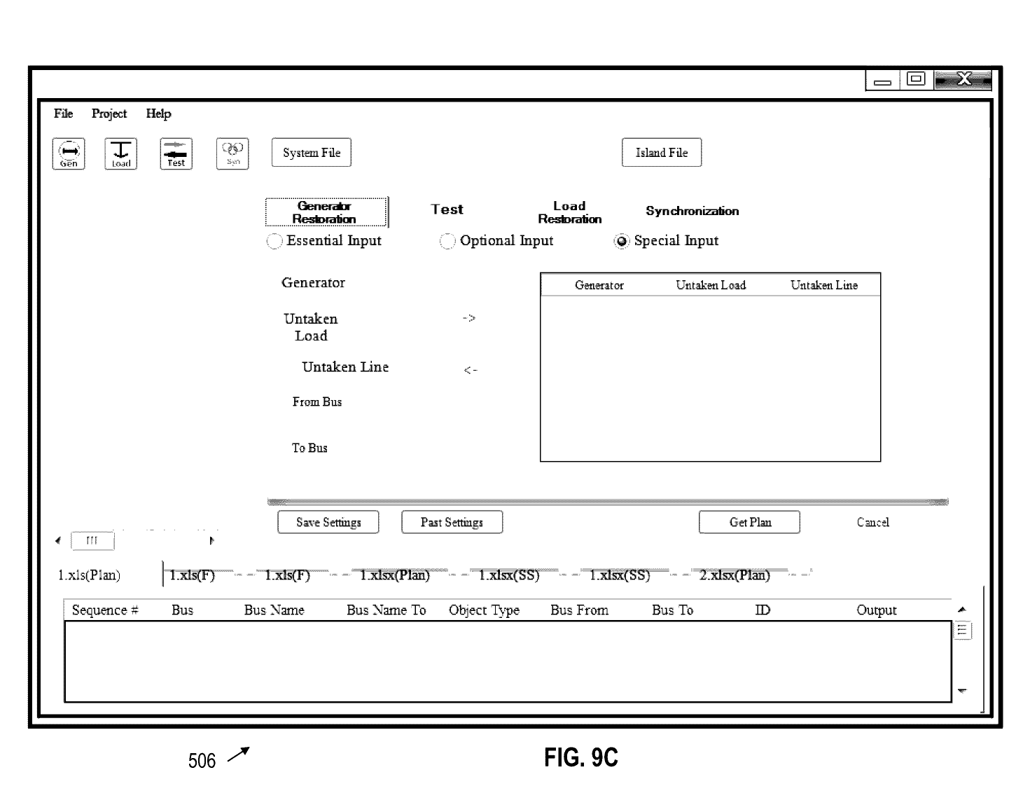

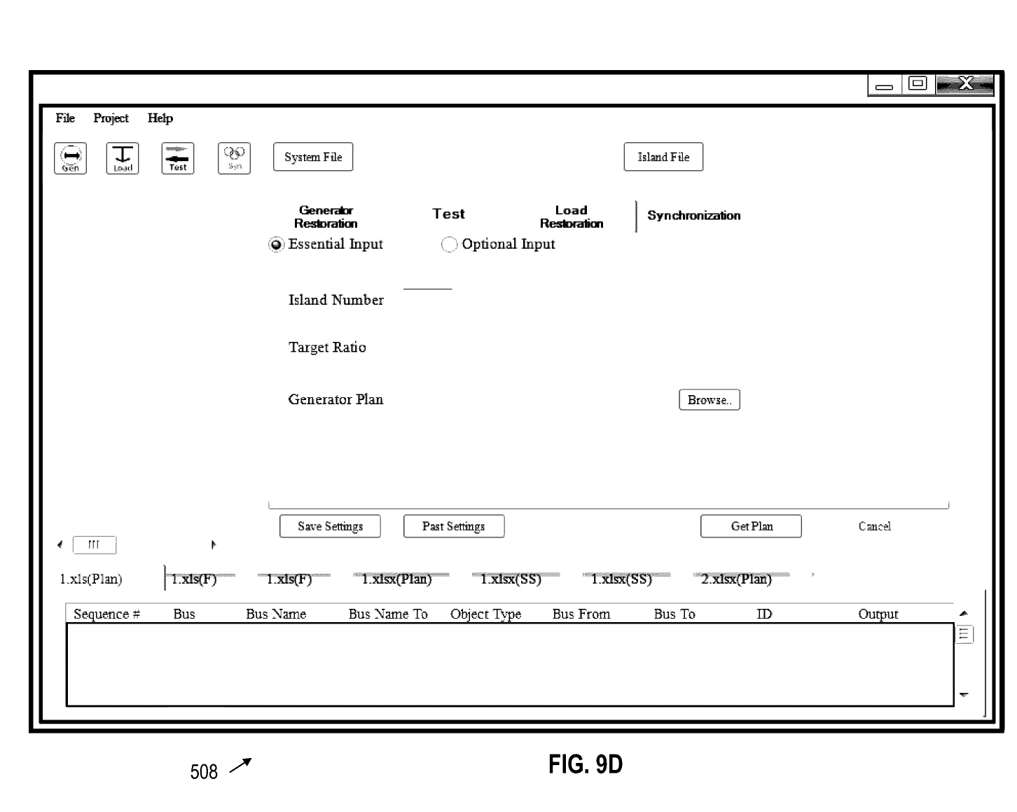

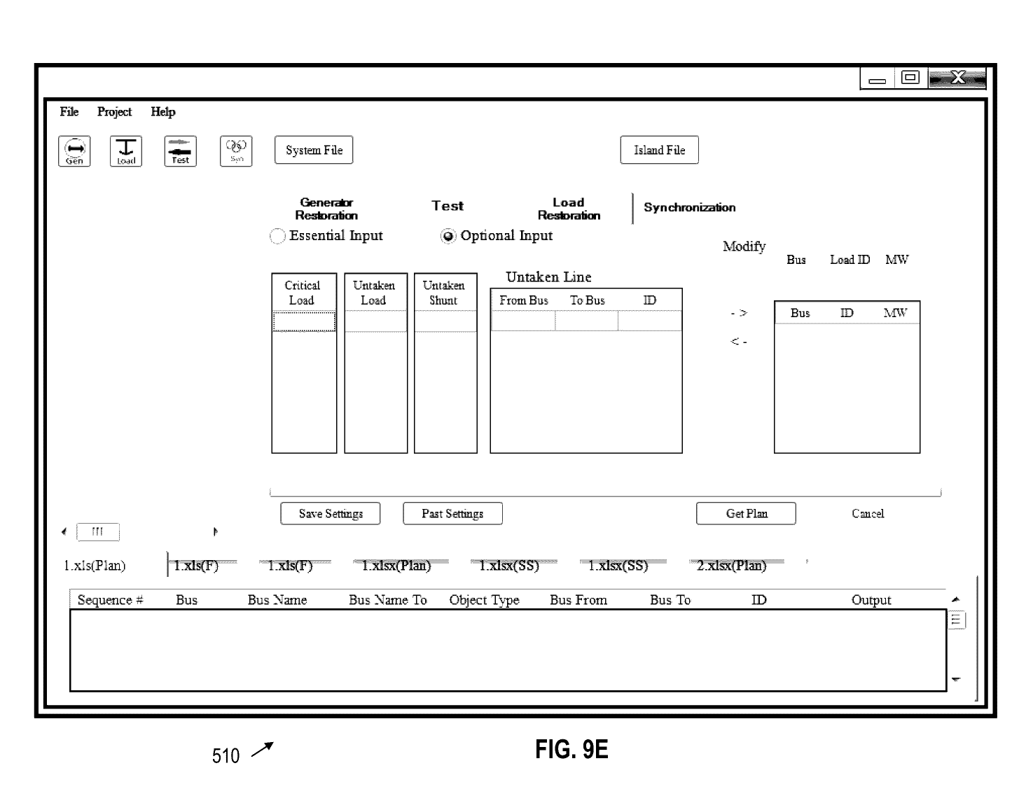

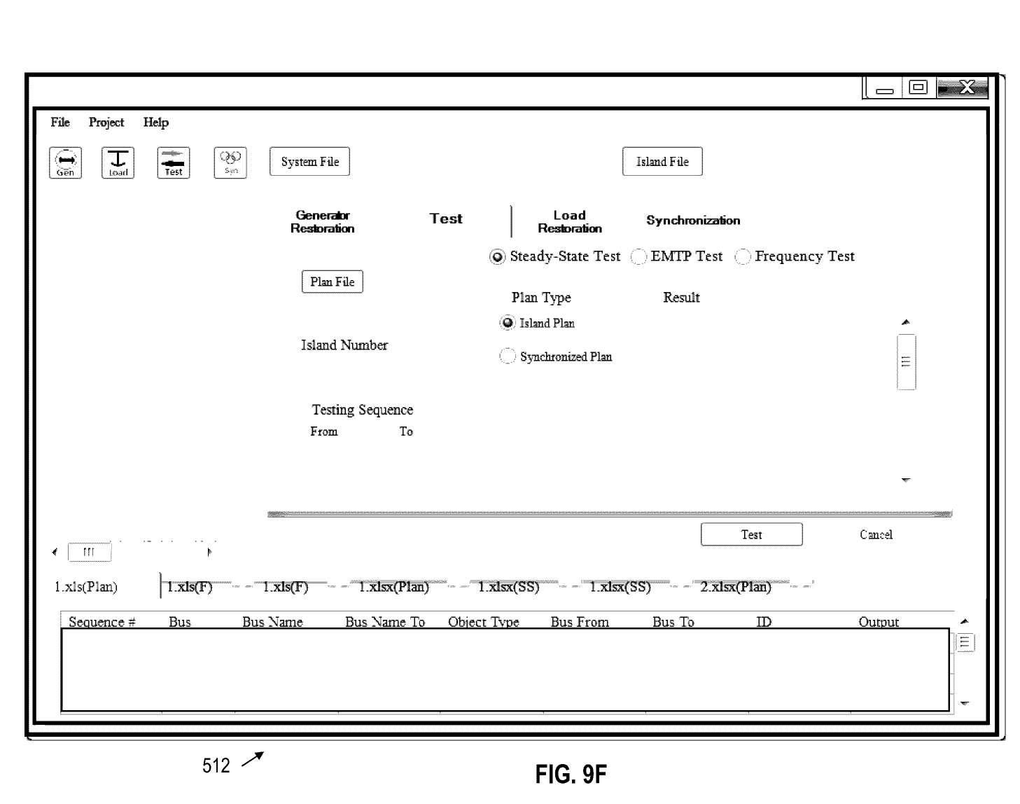

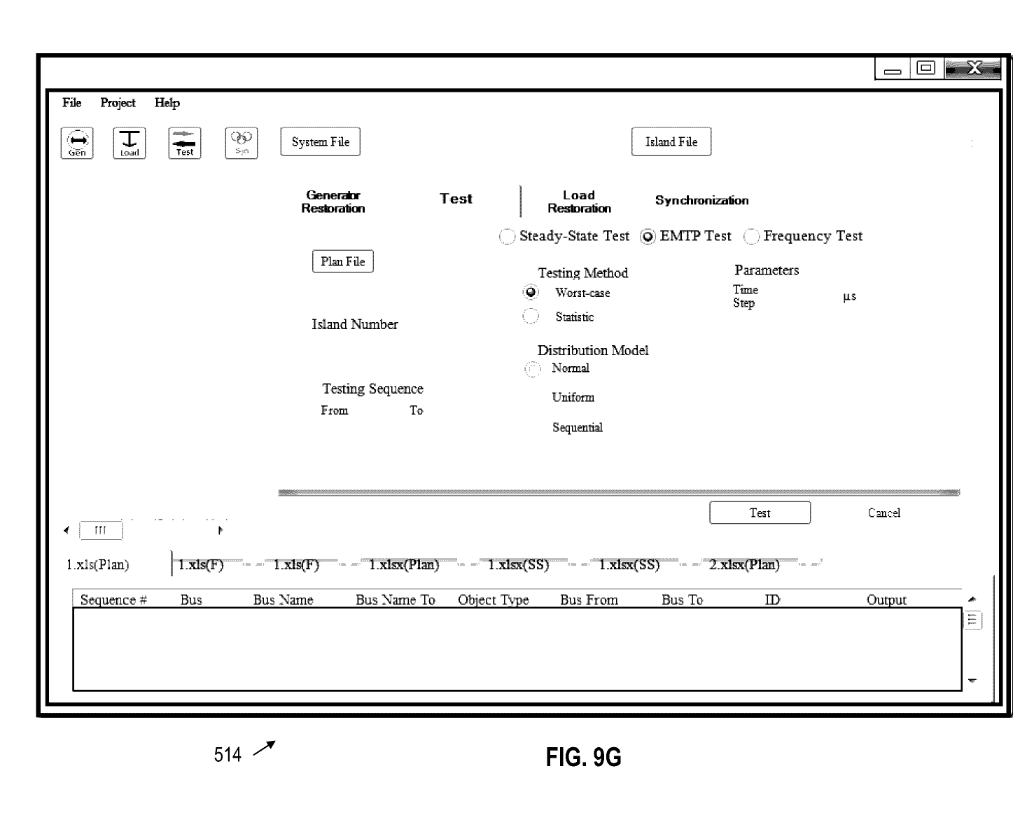

FIG. 8A shows an example IEEE system with 39 buses. Simulation results related to the example IEEE system of FIG. 8A, including frequency analysis tests results for multiple restoration stages, are represented in FIGS. 8B-8K. The simulations results were performed using PSS/E as a benchmark. As shown in FIG. 8A, the example power system includes 39 buses, 10 generators, 35 transmission lines, and 12 transformers. To restore the system and calculate the minimum average frequency, various assumptions are made as follows: 1) one load area will be picked up for each restoration stage; 2) a new load is restored when the system reaches the nominal rated frequency 60 Hz; 3) all generators in the system are modeled with a classical generator model; 4) the already restored load is modeled with a constant power component as well as a frequency dependent component; 5) the disturbance is small compared with the total rating of the island (i.e., the power can be absorbed by the generators).

In at least some embodiments, the proposed frequency analysis test involves the following: 1) solve steady state power flow before cold load pick up at each restoration stage; 2) identify cold load size, generator capacity and current power output; 3) identify generators inertia and damping for the already energized units; 4) estimate time constants used in the first-order governors already in-service; 5) identify the total load damping for the already restored load; 6) identify parameters for the cold load; 7) determine maximum Pᵢₙᵢ load size to pick up based on the total spinning reserve; 8) calculate the fast frequency response for the restoration stage. For example, the fast frequency response calculation may provide values for the initial slope during the inertial time, the minimum frequency, and the final settling frequency. The fast frequency response calculation may also provide timing information related to the minimum frequency and/or the final settling frequency.

In a first stage of power restoration, load bus 7 is picked up as represented in FIG. 8B. The frequency response calculated for the first stage of power restoration using the disclosed frequency analysis test and PEE/E is represented in FIG. 8C (the lines overlap). In a second stage of power restoration, load bus 8 is picked up as represented in FIG. 8D. The frequency response calculated for the second stage of power restoration using the disclosed frequency analysis test and PEE/E is represented in FIG. 8E (the lines overlap). In a third stage of power restoration, load bus 39 is picked up as represented in FIG. 8F. The frequency response calculated for the third stage of power restoration using the disclosed frequency analysis test and PEE/E is represented in FIG. 8G (the lines overlap). In a fourth stage of power restoration, load bus 4 is picked up as represented in FIG. 8H. The frequency response calculated for the fourth stage of power restoration using the disclosed frequency analysis test and PEE/E is represented in FIG. 8I. In a fifth stage of power restoration, load bus 21 is picked up as represented in FIG. 8J. The frequency response calculated for the fifth stage of power restoration using the disclosed frequency analysis test and PEE/E is represented in FIG. 8K. The simulation results indicate that satisfactory quantitative and qualitative frequency evaluation is possible using a reduced governor model (e.g., a first-order governor model).

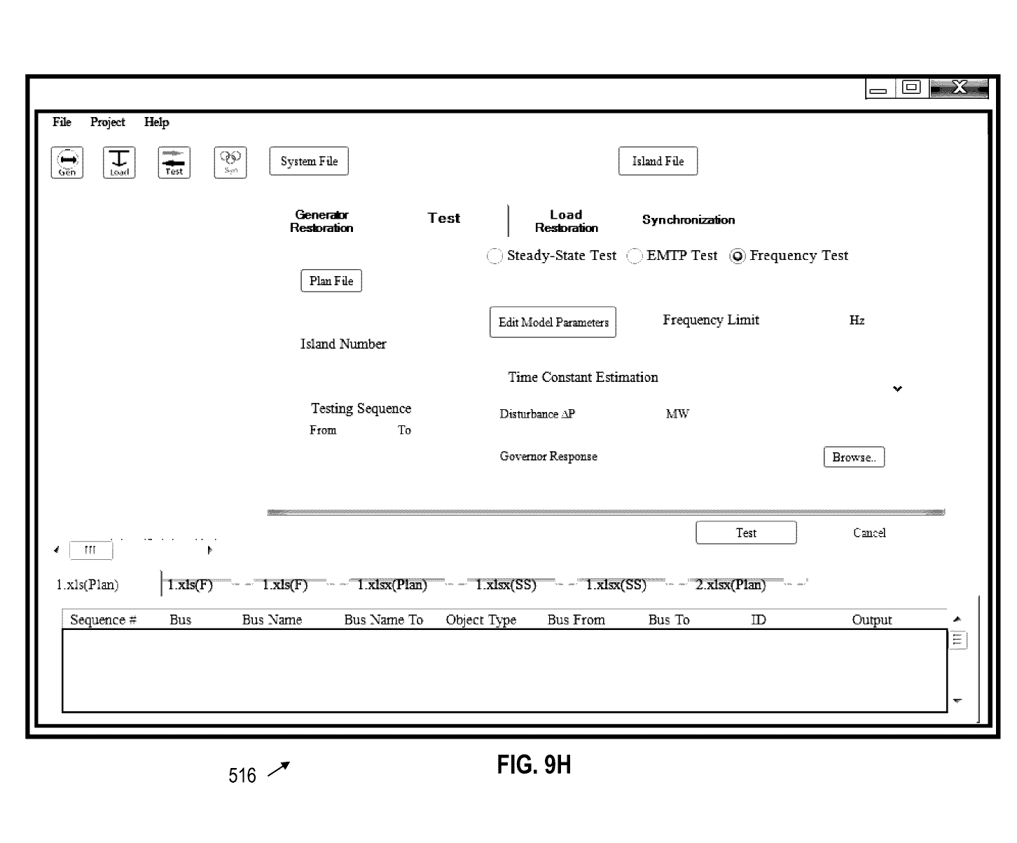

FIGS. 9A-9I show screenshots related to power restoration simulation software in accordance with an embodiment of the disclosure. In FIG. 9A, screenshot 502 shows tabs, buttons, or entry windows to enter various input parameters for generator restoration operations of the power restoration simulation application 210. For example, the input parameters may correspond to the following examples:
System File: system information including bus, generator, load and branch
Island File: bus number index in each island (subsystem) (result from sectionalization)
Essential Input:
   Island Number: the island number of the system for generator restoration
   Priority:
      Distance: the generators near black-start units are prior to be energized
      Capacity: the generators with larger minimum output are prior to be energized
   Generate New Path Mode:
      Starting Point: Staring point of the path
      Ending Point: Ending point of the path
   Modify Existing Path Mode:
      Starting Point: Starting point of the path
      Ending Point: Ending point of the path
   BS Units: black-start units
Optional Input: (shown in screenshot 504 of FIG. 9B)
   Load Ratio: the ratio of peak real power demand at load buses available for generator restoration (e.g., a value from 0 to 1)
   Critical Bus: high-priority bus to be energized
   Critical Generator: high-priority generator to be energized
   Generator Sequences: restoration sequence provided by user
   Untaken Generator: unavailable/unused generators during generator restoration
   Untaken Load: unavailable/unused loads during generator restoration
   Untaken Shunt: unavailable/unused shunts during generator restoration
   Untaken Line: unavailable/unused branches during generator restoration
Special Input: (shown in screenshot 506 of FIG. 9C)
   Generator: a selected generator to be energized
   Untaken Load: unavailable/unused loads when energizing the selected generator
   Untaken Line: unavailable/unused lines when energizing the selected generator

In FIG. 9D, screenshot 508 shows tabs, buttons, or entry windows to enter various input parameters for load restoration operations of the power restoration simulation application 210. For example, the input parameters may correspond to the following examples:
Essential Input:
   Island Number: the island number of the system for load restoration
   Target Ratio: target ratio of load to be energized in load restoration
   Generator Plan: a successful generator restoration plan
Optional Input: (shown in screenshot 510 of FIG. 9E)
   Critical Load: high-priority load to be energized
   Untaken Load: unavailable/unused generators during load restoration
   Untaken Shunt: unavailable/unused shunts during load restoration
   Untaken Line: unavailable/unused branches during load restoration
   Modify: modify bus, load ID, or peak real power demand

In FIG. 9F-9H, screenshots 512, 514, and 516 shows tabs, buttons, or entry windows to enter various input parameters for test operations of the power restoration simulation application 210. For example, the input parameters may correspond to the following examples:
Steady-State Test:
   Plan File: to select generator/load/island restoration plan
   Island Number: to select the island number for plan test
   Plan Type:
      Island Plan: restoration plan for a single island
      Synchronized Plan: restoration plan for multiple islands
   Testing Sequence: to test part of the restoration plan
   Result: steady-state test result
EMTP (transient) Test:
   Plan File: to select generator/load/island restoration plan
   Island Number: to select the island number for plan test
   Parameters:
      Time Step: the window (Δt) used for the transient test
   Testing Method:
      Worst-case: switch closes at the voltage peak
      Statistic: switch closes randomly under a given distribution
         Normal: normal distribution for statistic switching
         Uniform: uniform distribution for statistic switching
         Sequential: switch closes with the same time interval within a period
   Testing Sequence: to test part of the restoration plan
   For more information regarding transient test features, reference may be had to U.S. patent application Ser. No. 14/541,023, filed Nov. 13, 2014, and entitled “Methods and Systems for Power Restoration Planning Employing Simulation and Transient Test Analysis”.
Frequency Test (to perform frequency analysis test options as described herein):
   Plan File: to select generator/load/island restoration plan
   Island Number: to select the island number for plan test
   Edit Model Parameters:
      Generator inertia
      Generator damping
      Governor droop
      Peak value of the cold load
      Steady state value of the cold load
      Cold load damping
   Frequency Limit: to set a frequency threshold for the frequency analysis test
   Disturbance ΔP: to set an input disturbance used in the time constant estimation function
   Governor Response: a governor response file used in the time constant estimation function
   Testing Sequence: to test part of the restoration plan

In screenshot 516, the results of a frequency analysis test may be displayed in a table or spreadsheet format. For example, screenshot 516 shows a “Sequence” column, a “Bus Number” column, a “Bus Name” column, a “Bus Name To” column, an “Object Type” column, a “Bus From” column, a “Bus To” column, an “ID” column, and an “Output” column. Such columns can be populated with frequency test result data. For example, the Output column may display for each sequence of a power restoration simulation whether a frequency dropped below the threshold frequency selected for the test. Other types of information that could be obtained from the frequency analysis test include an initial frequency response slope value, a minimum frequency value, and/or a settling frequency value for each sequence or stage of power restoration. If more than one frequency analysis test is performed, the frequency analysis test results may be available by selecting different tabs to facilitate review and analysis of the different frequency analysis test results.

In FIG. 9I, screenshot 518 shows tabs, buttons, or entry windows to enter various input parameters for synchronization operations of the power restoration simulation application 210. For example, the input parameters may correspond to the following examples:
Plan I:
   Island Number 1: island number for Plan I
Plan II:
   Island Number 2: island number for Plan II
Untaken Line: unavailable/unused line during synchronization

As desired, a user may switch between different screens by selecting respective buttons or tabs. In this manner, the features of the power restoration simulation application 210 can be accessed, updated, results reviewed, etc. While specific information is not shown, file directory information may be displayed as desired. Further, File menu, Project menu, and Help menu options are available. Example File menu features include: generating system file from PowerWorld file, and generating an island file from a system file. Example Project menu features include setting maximum simulation time. Example Help menu features include software information and user manual.

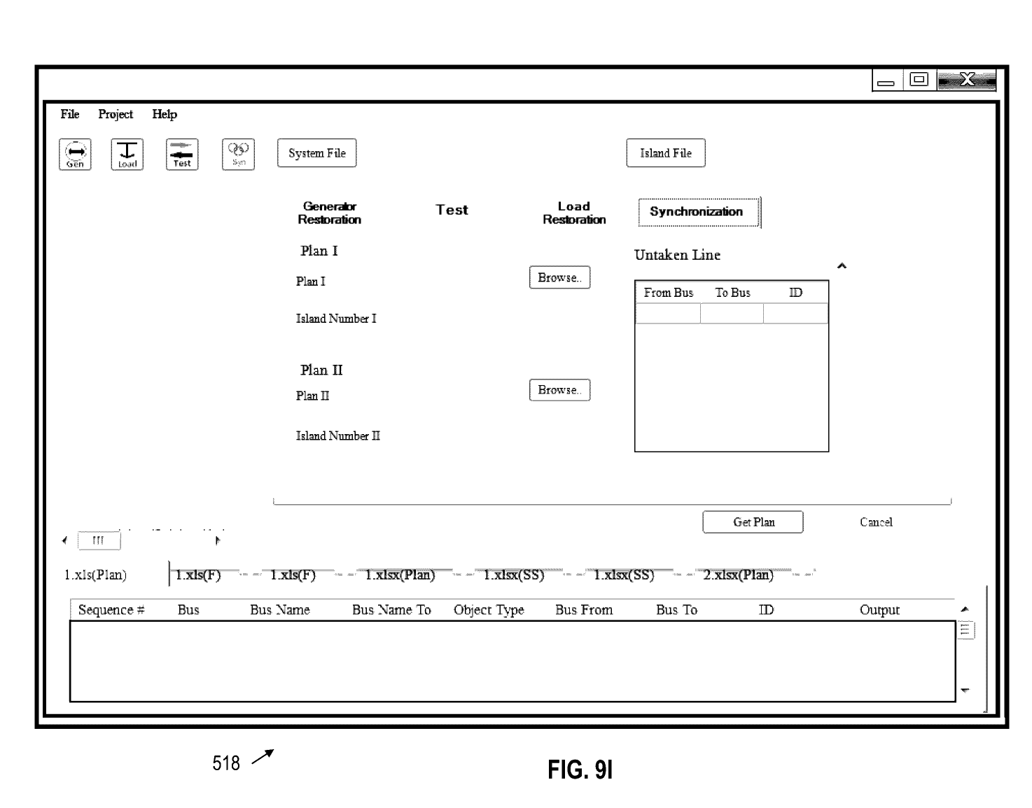

FIG. 10 is a flowchart showing an illustrative power restoration planning method 600. The method 600 may be performed, for example, by the computer system 200 of FIG. 2 and/or other computing components. As shown, the method 600 comprises simulating a restoration of a power grid system at block 602. At block 604, a frequency analysis test is performed for the simulated restoration. Various frequency analysis test options are possible as described herein. At block 606, a restoration plan is generated for the power grid system based on the simulation and the frequency analysis test results. As an example, a user may use the restoration plan, including the frequency analysis test results, to make decisions regarding how to restore power after a black-out. Further, changes to components of a power grid systems and/or connections between components may be based at least in part on a restoration plan, including the frequency analysis test results, provided by method 600.

In at least some embodiments, performing the frequency analysis test as in block 604 involves employing a first-order governor model. Further, performing the frequency analysis test as in block 604 may involve estimating a time constant used in the first-order governor model. For example, in at least some embodiments, the time constant used in the first-order governor model is estimated based on a weighted minimum frequency error value, a weighted initial frequency response slope error value, a weighted time to reach minimum frequency error value, and a weighted steady state frequency error value. Further, performing the frequency analysis test as in block 604 may involve a system model having a forward loop with an aggregated generator model, and a feedback loop with a reduced governor model. Further, performing the frequency analysis test as in block 604 may involve providing a cold load value as an input to the system model, where the cold load value is obtained using a linearized cold load model. Further, performing the frequency analysis test as in block 604 may involve determining limits for a first-order governor model based on steady state analysis results. In at least some embodiments, performing the frequency analysis test as in block 604 may involve obtaining separate frequency analysis test for each of a plurality of simulated restoration stages. Further, performing the frequency analysis test as in block 604 may involve displaying the frequency analysis test results on a monitor.

FIG. 10 is a block diagram showing illustrative component of a computer system 700. The computer system 700 may correspond to computer system 200 or similar computing devices capable of executing instructions to perform power restoration simulation, including frequency analysis test operations, as described herein. The computer system 700 may correspond to, for example, components of the computer system 200 described herein.

As shown, the computer system 700 includes a processor 702 (which may be referred to as a central processor unit or CPU) that is in communication with memory devices including secondary storage 704, read only memory (ROM) 706, random access memory (RAM) 708, input/output (I/O) devices 710, and network connectivity devices 712. The processor 702 may be implemented as one or more CPU chips.

It is understood that by programming and/or loading executable instructions onto the computer system 700, at least one of the CPU 702, the RAM 708, and the ROM 706 are changed, transforming the computer system 700 in part into a particular machine or apparatus having the novel functionality taught by the present disclosure. In the electrical engineering and software engineering arts functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. For example, a design that is still subject to frequent change may be implemented in software, because re-spinning a hardware implementation is more expensive than re-spinning a software design. Meanwhile, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 704 may be comprised of one or more disk drives or tape drives and is used for non-volatile storage of data and as an over-flow data storage device if RAM 708 is not large enough to hold all working data. Secondary storage 704 may be used to store programs which are loaded into RAM 708 when such programs are selected for execution. The ROM 706 is used to store instructions and perhaps data which are read during program execution. ROM 706 is a non-volatile memory device which typically has a small memory capacity relative to the larger memory capacity of secondary storage 704. The RAM 708 is used to store volatile data and perhaps to store instructions. Access to both ROM 706 and RAM 708 is typically faster than to secondary storage 704. The secondary storage 704, the RAM 708, and/or the ROM 706 may be referred to in some contexts as computer readable storage media and/or non-transitory computer readable media.

I/O devices 710 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 712 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 712 may enable the processor 1202 to communicate with the Internet or one or more intranets. With such a network connection, it is contemplated that the processor 702 might receive information from the network, or might output information to the network in the course of performing the above-described method steps. Such information, which is often represented as a sequence of instructions to be executed using processor 702, may be received from and outputted to the network, for example, in the form of a computer data signal embodied in a carrier wave.

Such information, which may include data or instructions to be executed using processor 702 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods known to one skilled in the art. The baseband signal and/or signal embedded in the carrier wave may be referred to in some contexts as a transitory signal.

The processor 702 executes instructions, codes, computer programs, scripts which it accesses from hard disk, floppy disk, optical disk (these various disk based systems may all be considered secondary storage 704), ROM 706, RAM 708, or the network connectivity devices 712. While only one processor 702 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 704, for example, hard drives, floppy disks, optical disks, and/or other device, the ROM 706, and/or the RAM 708 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 1200. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the power restoration simulation and planning techniques disclosed herein are related to a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 704, to the ROM 706, to the RAM 708, and/or to other non-volatile memory and volatile memory of the computer system 700. The processor 702 may process the executable instructions and/or data structures in part by directly accessing the computer program product, for example by reading from a CD-ROM disk inserted into a disk drive peripheral of the computer system 700. Alternatively, the processor 702 may process the executable instructions and/or data structures by remotely accessing the computer program product, for example by downloading the executable instructions and/or data structures from a remote server through the network connectivity devices 712. The computer program product may comprise instructions that promote the loading and/or copying of data, data structures, files, and/or executable instructions to the secondary storage 704, to the ROM 706, to the RAM 708, and/or to other non-volatile memory and volatile memory of the computer system 700.

In some contexts, the secondary storage 704, the ROM 706, and the RAM 708 may be referred to as a non-transitory computer readable medium or a computer readable storage media. A dynamic RAM embodiment of the RAM 708, likewise, may be referred to as a non-transitory computer readable medium in that while the dynamic RAM receives electrical power and is operated in accordance with its design, for example during a period of time during which the computer 700 is turned on and operational, the dynamic RAM stores information that is written to it. Similarly, the processor 702 may comprise an internal RAM, an internal ROM, a cache memory, and/or other internal non-transitory storage blocks, sections, or components that may be referred to in some contexts as non-transitory computer readable media or computer readable storage media.

In some examples, a non-transitory computer-readable storage medium may store a program or instructions that cause the processor 702 to simulate restoration of a power grid system, to perform a frequency analysis test for the simulated restoration, and to generate a restoration plan for the power grid system based on the simulation and frequency analysis test results. In at least some embodiments, the processor 702 is in communication with a display such that a program or instructions, when executed, cause the processor 702 to provide a user interface on the display that enables a user to select frequency analysis test options (see e.g., FIG. 9H). Further, the instructions, when executed, may cause the processor 702 to provide a user interface on the display that enables a user to view frequency analysis test results for a restoration plan.

In at least some embodiments, the program or instructions cause the processor 702 to perform a frequency analysis test using a first-order governor model. Further, the program or instructions may cause the processor 702 to estimate a time constant used in the first-order governor model. As an example, the time constant may be estimated based on a weighted minimum frequency error value, a weighted initial frequency response slope error value, a weighted time to reach minimum frequency error value, and a weighted steady state frequency error value. Further, the program or instructions may cause the processor 702 to perform a frequency analysis test using a system model having a forward loop with an aggregated generator model, and a feedback loop with a reduced governor model. Further, the program or instructions may cause the processor 702 to provide a cold load value as an input to the system model, where the cold load value is obtained using a linearized cold load model. Further, the program or instructions may cause the processor 702 to perform the frequency analysis test by determining limits for a first-order governor model based on steady state analysis results. In at least some embodiments, the program or instructions may cause the processor 702 to perform separate frequency analysis test for each of a plurality of simulated restoration stages. Further, the program or instructions may cause the processor 702 to display the frequency analysis test results on a monitor.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Without limitation to other embodiments, various concepts are described herein including the following:
Separate phases of frequency analysis test: This concept is to separate the frequency analysis test during power restoration simulation into three processes: dynamic model creation, parameter estimation and frequency calculation. The objective for dynamic model creation is to create dynamic models automatically for frequency analysis. The objective for parameter estimation is to identify the time constant in the simplified governor model. The objective for frequency calculation is to calculate frequency response for cold load pick up.
First-order governor model approximation: During dynamic model creation, a simplified first-order governor model is generated to approximate a complete governor model.
Criteria for parameter estimation in the first-order governor model: During parameter estimation, a time constant for the first-order governor model is estimated based on: 1) steady state frequency; 2) the time to reach the minimum frequency; 3) initial frequency slope; and 4) minimum frequency.
Parameter estimation in the first-order governor model: During parameter estimation, an isolated generator model and multi-objectives optimization is used to estimate the time constant for the first-order governor model.
Determination of initial status for frequency analysis test: During frequency calculation, steady state results from power flow in the previous restoration step are used to determine governor limits.
Linearization of cold load model: During dynamic model creation, a linearized cold load model is used to describe the inrush cold load characteristics.
Closed-loop feedback control system model for frequency analysis test: During frequency calculation, a system model with an aggregated generator model in the forward loop and a simplified governor model in the feedback loop is used. The input of this system model is the imbalance between governor outputs and cold load value, and the output of this system model is the frequency variation.
Criteria for frequency stability measurement: During frequency calculation, frequency stability is assessed using: 1) initial frequency slope 2) minimum frequency 3) settling frequency

It should be appreciated that the techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Numerous variations and modifications will become apparent to those skilled in the art once the above disclosure is fully appreciated. It is intended that the following claims be interpreted to embrace all such variations and modifications.

What is claimed is:

1. A computer system, comprising:
at least one processor; and
a storage device coupled to the at least one processor and storing instructions that, when executed, causes the at least one processor to:
simulate restoration of a power grid system;
perform a frequency analysis test for the simulated restoration; and
generate a restoration plan for the power grid system based on the simulation and frequency analysis test results.

2. The computer system of claim 1, wherein the frequency analysis test results include an initial frequency response slope, a minimum frequency, and a settling frequency.

3. The computer system of claim 1, wherein the instructions, when executed, cause the at least one processor to perform the frequency analysis test based on a first-order governor model.

4. The computer system of claim 3, wherein the instructions, when executed, cause the at least one processor to estimate a time constant used in the first-order governor model.

5. The computer system of claim 4, wherein the instructions, when executed, cause the at least one processor to estimate the time constant as a function of a minimum frequency error value, an initial frequency response slope error value, a time to reach minimum frequency error value, and a steady state frequency error value.

6. The computer system of claim 5, wherein the instructions, when executed, cause the at least one processor to estimate the time constant by weighting said values.

7. The computer system of claim 2, wherein the instructions, when executed, cause the at least one processor to perform the frequency analysis test based on a system model having a forward loop with an aggregated generator model, and a feedback loop with the governor model approximation.

8. The computer system of claim 7, wherein the instructions, when executed, cause the at least one processor to provide a cold load value as an input to the system model, wherein the cold load value is obtained using a linearized cold load model.

9. The computer system of claim 3, wherein the instructions, when executed, cause the at least one processor to determine limits for the first-order governor model based on steady state analysis results.

10. The computer system of claim 1, wherein the instructions, when executed, cause the at least one processor to perform a separate frequency analysis test for each of a plurality of simulated restoration stages.

11. The computer system of claim 1, further comprising a display in communication with the at least one processor, wherein the instructions, when executed, cause the at least one processor to provide a user interface on the display that enables a user to select frequency analysis test options.

12. The computer system of claim 1, further comprising a display in communication with the at least one processor, wherein the instructions, when executed, cause the at least one processor to provide a user interface on the display that enables a user to view frequency analysis test results for a restoration plan.

13. A method, comprising:
simulating, by at least one processor, a restoration of a power grid system;
performing, by the at least one processor, a frequency analysis test for the simulated restoration; and
generating, by the at least one processor, a restoration plan for the power grid system based on the simulation and frequency analysis test results.

14. The method of claim 13, wherein performing the frequency analysis test comprises employing a first-order governor model.

15. The method of claim 13, wherein performing the frequency analysis test comprises estimating a time constant used in the first-order governor model.

16. The method of claim 15, wherein estimating the time constant involves balancing a weighted minimum frequency error value, a weighted initial frequency response slope error value, a weighted time to reach minimum frequency error value, and a weighted steady state frequency error value.

17. The method of claim 13, wherein performing the frequency analysis test involves a system model having a forward loop with an aggregated generator model, and a feedback loop with the governor model approximation.

18. The method of claim 17, wherein performing the frequency analysis test processor comprises:
providing a cold load value as an input to the system model, wherein the cold load value is obtained using a linearized cold load model; and
determining limits for a first-order governor model based on steady state analysis results.

19. The method of claim 13, wherein performing the frequency analysis test comprises obtaining separate frequency analysis test for each of a plurality of simulated restoration stages.

20. The method of claim 13, further comprising displaying the frequency analysis test results on a monitor.
